(19) United States
(12) Patent Application Publication
(10) Pub. No.: US 2004/0015868 A1
(43) Pub. Date: Jan. 22, 2004

(54) Beta version processing system

(75) Inventors: Rabindranath Dutta, Austin, TX (US); Janani Janakiraman, Austin, TX (US)

Correspondence Address: Robert V. Wilder, Attorney at Law, 4235 Kingsburg Drive, Round Rock, TX, 78681, US

(73) Assignee: International Business Machnies Corporation, Armonk, NY (US)

(21) Appl. No.: 09/852,775

(22) Filed: May 10, 2001

(51) Int. Cl. G06F 9/44

(52) U.S. Cl. 717/126; 717/168

(57) ABSTRACT

A method and implementing system are provided in which customers of an Application Service Provider (ASP) are enabled to access an upgraded version of a software application being used by the customer without interfering with the use and access by the customer of the current version of the software application for which the upgrade is offered. In an exemplary embodiment, a customer is notified that an upgraded version of an application accessed by the customer is available for testing. The customer is enabled to input whether the customer wishes to test the upgraded application version. If the customer selects to test the upgraded version, the customer is made aware of an upgrade site or address which is arranged to host the upgrade. The customer is further enabled to access the upgrade site to access and test the upgraded application. The customer/tester is also enabled to provide feedback to the ASP regarding the features and feasibility of the upgraded application, and the feedback is automatically analyzed to make a determination as to the release-readiness of the upgrade software.

### RELATED APPLICATIONS

Subject matter disclosed and not claimed herein is disclosed and claimed in related co-pending application, Attorney Docket AUS920010181US1, which is assigned to the assignee of the present application.

### FIELD OF THE INVENTION

The present invention relates generally to information processing systems and more particularly to a methodology and implementation for testing and providing upgraded versions of application programs.

### BACKGROUND OF THE INVENTION

The Internet is enabling ever increasing levels of communication among enterprises and organizations which have a web site on the World Wide Web. Application Service Providers (ASPs) are becoming a key component in the broadening scope of communications made possible through the Internet. Such ASPs are a central element in providing business methods or processes for the Internet.

The ASP Industry Consortium defines an ASP as an organization that “manages and delivers application capabilities to multiple entities from a data center across a wide area network (WAN)”. Thus, entities are able to “rent” access to software over the Internet or a WAN for a fee. The fees are typically incurred with the use of the access to various application programs so that the user only has to pay for the amount of time which the user actually uses the rented application program. This arrangement changes the nature of application usage such that the user is provided a “service” over a network rather than becoming an owner and maintainer of application programs. An “ASP” is currently used to describe a company that hosts applications on centralized servers. In the ASP model, customers pay a “hosting fee” to access the applications from a remote site over a network. Further, the application code is not maintained by the customer but rather by the ASP or other entity specifically charged with such maintenance. Technical support may also be provided by an entity separate from both the ASP and the customer or end user. Thus, the functions of hosting, maintaining and providing technical support for hosted applications are separate functions and may be performed by separate entities. Many Independent Software Vendors (ISVs) will provide a complete array of application services (e.g. hosting, delivery and support), while others may team with ASPs and other business partners to offer these services to their customers.

As the development of the Internet continues to expand, the Internet software market has evolved from mostly custom applications to a market increasingly dominated by applications, i.e. a common application is driving business practices rather than particular business practices being encoded into custom applications. More and more software is being “delivered” over the Internet and this trend toward more common or so-called “packaged software”, has been readily accepted in the marketplace. In the ASP environment, the software “delivery” is in the form of access to an ASP site which is hosting the application. Thus, the delivery and implementation of upgrades for Application Services provided over a network is considered to be a potential problem area. Because most applications in the ASP model are integral to the customer's business (e.g. payroll, HR, accounting, etc.) most customers will not readily agree to an upgrade without first thoroughly studying and testing the upgraded version which may be offered by the software vendor. Further, the task of evaluating customer input with regard to beta versions of new software has been tedious in the past and improvements in the expediency of accomplishing such analysis is needed.

Thus, there is a need for an improved methodology by which customers of application services may be enabled to become familiar with upgraded versions of applications prior to committing to access and use the upgraded version in the customer's business enterprise. There is a still further need to provide an improved analysis technique for automatically analyzing tester input provided by existing customers of application services.

### SUMMARY OF THE INVENTION

A method and implementing system are provided in which customers of an Application Service Provider (ASP) are enabled to access an upgraded version of a software application being used by the customer without interfering with the use and access by the customer of the current version of the software application for which the upgrade is offered. In an exemplary embodiment, a customer is notified that an upgraded version of an application accessed by the customer is available for testing. The customer is enabled to input whether the customer wishes to test the upgraded application version. If the customer selects to test the upgraded version, the customer is made aware of an upgrade site or address which is arranged to host the upgrade. The customer is further enabled to access the upgrade site to access and test the upgraded application without interfering with the customer's current access of the application at a current site or address. The customer is also enabled to provide feedback to the ASP regarding the features and feasibility of the upgraded application. Subjective feedback from the customers testing the upgrade software is automatically quantified and analyzed to provide an indication of the release-readiness of the upgrade program.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary system in which the present invention may be implemented;

FIG. 2 is a schematic block diagram of several key components of a typical computer system;

FIG. 3 is a schematic diagram illustrating several of the major steps in the methodology associated with the present invention;

FIG. 4 is a detailed flow chart illustrating an exemplary operational sequence in one implementation of the present invention;

FIG. 5 is an illustration of an exemplary form questionnaire which may be used in soliciting comments from testers of an upgrade application; and

FIG. 6 is a flow chart illustrating the evaluation analysis process for evaluating the comments submitted by testers of an upgrade application.

### DETAILED DESCRIPTION

The various methods discussed herein may be implemented within a typical computer-related system such as a server which may include a workstation. In the example illustrated, a customer's network server connects through the Internet to an Application Service Provider (ASP) server. In general, an implementing computer system such as the customer's server or the ASP server may include a plurality of processors in a multi-bus system in a network of similar systems. However, since the workstation or computer system used in practicing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

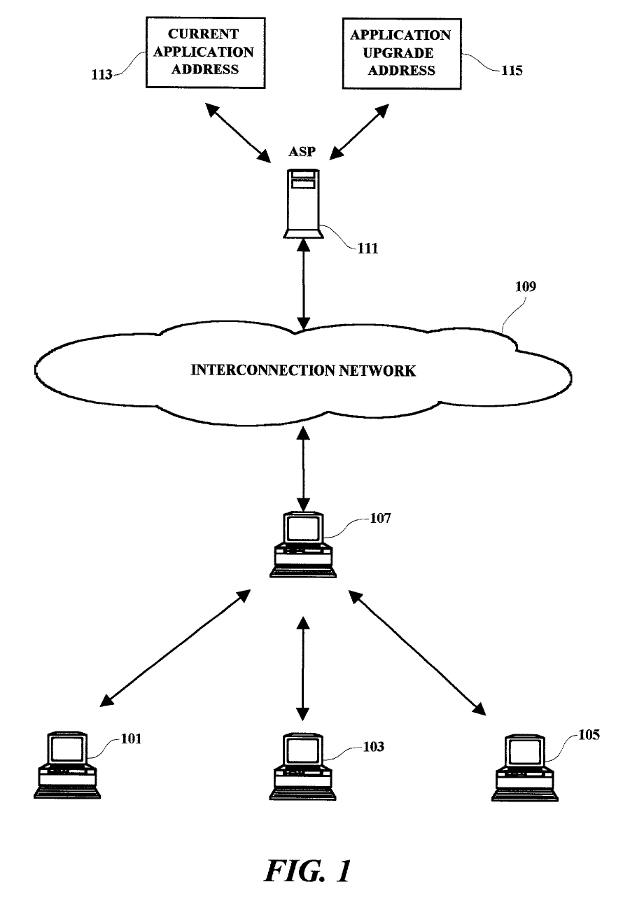

In FIG. 1, there are shown a series of computer terminals 101, 103 and 105 which are connected in a network configuration to a network server 107. The network server is operating in an ASP mode in which the server 107 connects through an interconnection network 109, such as the Internet, to an ASP server 111. The ASP server runs the application being used by the network server 107, and network server 107 merely “rents” the application being executed at the ASP server 111, and pays for the time that the ASP application is being used by the network server 107. ASP applications include applications such as Payroll programs, Human Resources programs or other programs that have wide application to corporate clients for example. The ASP server 111 provides the current application for use by the network server 107 from a current application address 113. As upgrades or upgraded versions of the current application are developed, the upgrade is stored and accessible from an application upgrade address 115, which is different from the current application address. The application upgrade address may also be made available at a totally different site from that at which the current application is accessed.

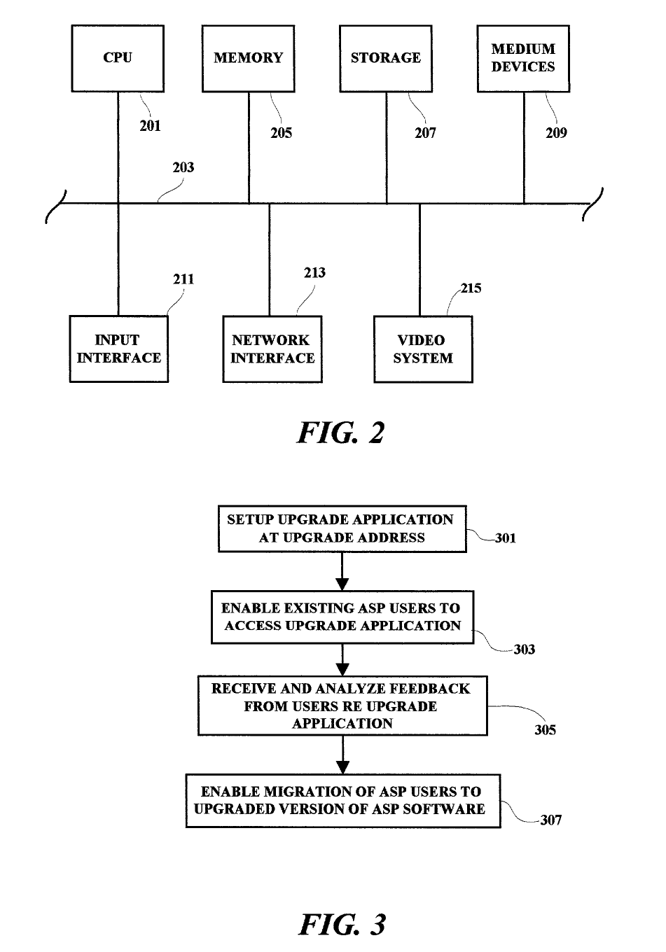

In FIG. 2, there is illustrated a block diagram of several of the components of the network server 107. The illustrated components are also typical of the ASP server 111. As shown in the FIG. 2 example, a central processing unit (CPU) 201 is connected to a system bus 203. The system bus is also connected to a memory device 205, a storage system 207, and medium devices 209 such as diskette and/or CD drives. Also shown is an input interface 211 to enable a user or server administrator to interact with the server. The input interface 211 may be connected to a keyboard and/or a mouse or other pointing device as is well known. The system bus is also selectively coupled to a network interface 213 which may be used to connect the network server, for example, through the interconnection network 109 to the ASP server 111. The ASP server uses a similar configuration to access the current application and the upgraded application and to connect with the network server 107. The exemplary block diagram of FIG. 2 also includes a video system 215 which is used to display the various screen displays and selection options to the administrator.

As shown in FIG. 3, in a high level sequence of the methodology implemented in an exemplary embodiment, when an ASP has developed an upgrade for a current application being currently accessed by customers, the ASP will need to have potential users of the upgrade run and test the upgrade before implementing the upgrade to all current customers. In the past, this kind of testing for new applications and upgrades had been accomplished by sending out so-called “beta” versions of the upgrade to be tested. However, in an ASP environment, this is not feasible since the current customers will not wish to risk accessing the upgrade until it has been thoroughly tested and found to be generally acceptable. With the ASP model of software, the ASPs can set up the new version of the software on a server and allow the existing registered users to run against the new version without having to upgrade their client code. The registered users can then provide feedback on the use of the upgrade and the ASP can migrate the new version when the upgrade has been thoroughly checked and the user input has been analyzed and accommodated. After it is determined that the upgrade is in a form acceptable to the customer base and the ASP, the ASP simply points to the upgrade site, for example, instead of the current site when access to the application is requested. Thus, after the upgrade is set up at the upgrade site 301, existing ASP users are enabled to access the upgraded version 303 and after feedback is received and analyzed from the existing users with regard to the upgrade 305, the ASP may then enables migration of the ASP users to the upgraded version of the application 307 at the upgrade site.

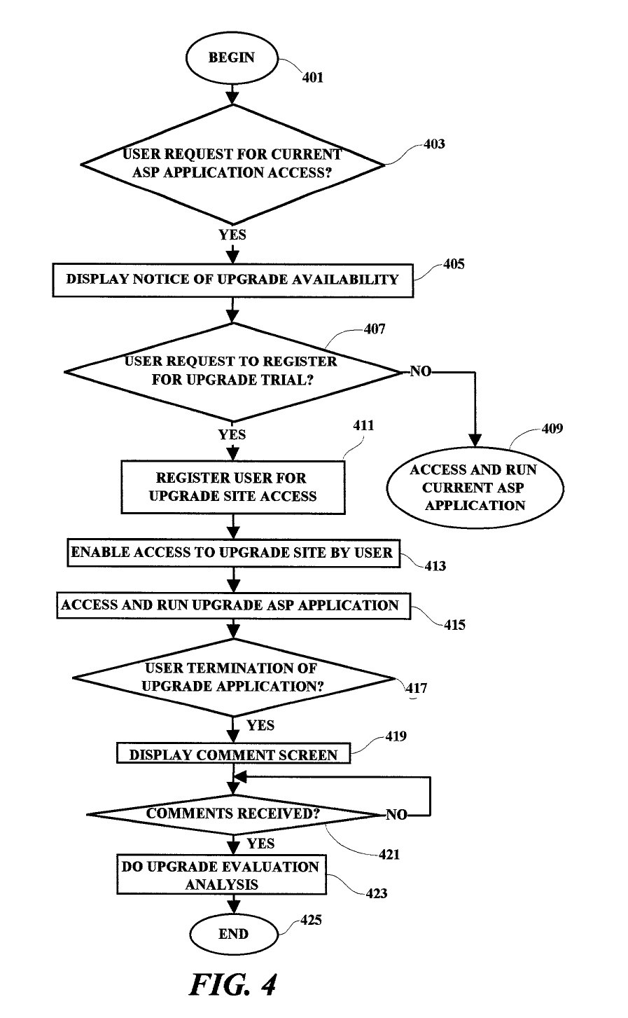

As shown in FIG. 4 in more detail, when the process begins 401, and a user request for the current ASP application is detected 403, a notice is displayed to the administrator of the network server 107 that an upgraded version of the application is available for testing 405. If the user does not wish to test the upgraded version 407, the ASP accesses the current application 409 for use by the network server 107. If, however, the user does request to test the upgraded version 407, then the user is registered for access to the upgrade site 411 and the ASP enables access 413 to the upgrade version of the application by the user. The upgrade version of the ASP application is then accessed and executed at the ASP 415 for use by the registered user. When the user wishes to terminate the session with the upgrade application 417, a comment screen may be displayed 419 so that the user may input comments regarding the upgraded version. After the comments have been received 421, the comments are quantified and analyzed 423 and the upgrade comment analysis processing ends 425.

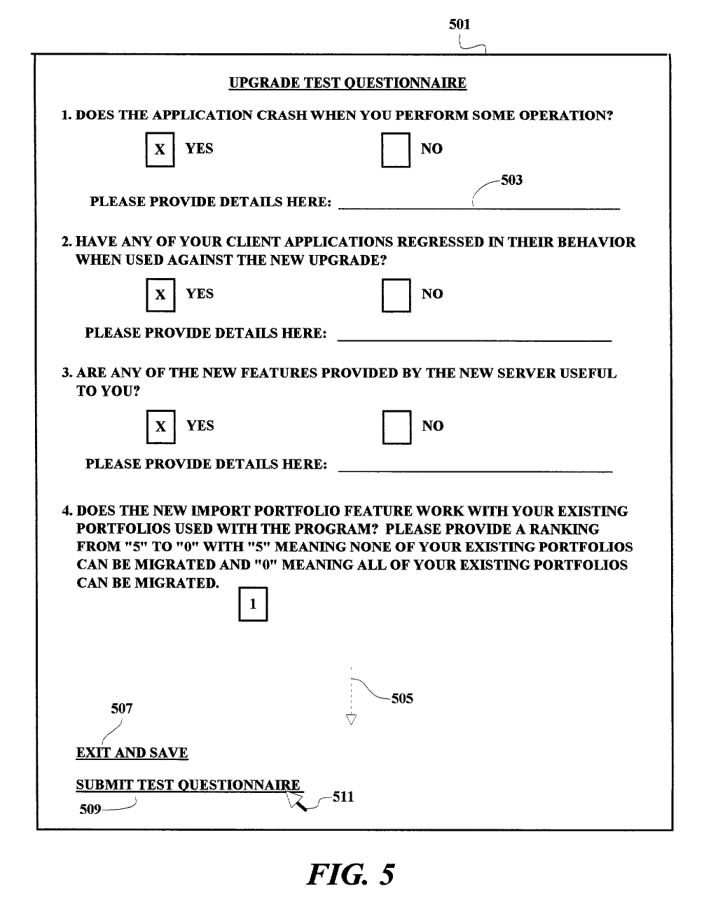

An example of a format that may be used in soliciting comments from individuals who are testing the upgrade software program is illustrated in FIG. 5. As shown, the format 501 may be called and displayed on a tester's display device when it is detected that the tester has finished testing the upgrade and wishes to exit. The illustrated exemplary questionnaire includes a predetermined number of questions to which various kinds of answers may be provided by the tester. In general, each question has an importance attached to it relative to other questions, and the importance of each individual question will vary depending upon the nature of the upgrade software being analyzed or tested. However, one of the more serious problems that can arise during a test run would be a so-called application “crash”, i.e. when the tester performs a function and the program being tested no longer properly responds to user input or responds with an improper action. As shown in FIG. 5, a tester is enabled to indicate when a crash occurs by inputting an “x” or check in a block associated with the first question. Further, if the tester did experience a crash, there is a place 503 to type-in the related details of the crash so that the problem can be addressed and corrected after the questionnaire is returned to the ASP. The crash question is the most important relative to the underlying question of whether or not the upgrade software is ready for release. Thus the answer to the crash question will have attached to it the most weight or importance in the subsequent analysis of the submitted answers to the questionnaire.

Other questions of lesser but significant importance include questions about usefulness of the new features, ease of use of the new features, the effect of the upgrade software on the tester's existing files which are used with the base program, etc. In general, each question is followed by multiple choice or “Yes/No” answers which can be automatically read and analyzed with a computer program. Thus the entire process of distributing a “beta” test questionnaire to knowledgeable users, receiving answers from the users or testers and analyzing those answers can be done automatically with a computer program as herein disclosed.

The weighting of answers may be accomplished by attaching a number relative to a larger scale to each answer. For example, the answer to the second question “HAVE ANY OF YOUR CLIENT APPLICATIONS REGRESSED IN THEIR BEHAVIOR WHEN USED AGAINST THE NEW UPGRADE?” may have a rating or weighting factor of “300” such that a “NO” answer (indicating no problem with regression) will be assigned a score of “0” but a “YES” answer will be assigned a score of “300”. Similarly, the third question may have an importance factor of “100” attached to it. Accordingly, if the third question receives a “YES” answer, then a “0” is assigned to that answer but if the answer is “NO”, then a “100” is assigned to that answer during answer analysis processing. In the example, negative weighting is used, i.e. the higher the assigned weighted score, the more problems there are with the upgrade software. However, it is understood that the questions may also be designed to accommodate positive weighting such that greater weighting is assigned to more positive input or fewer problems. The weighting function allows the quantification of the subjective answers which, in turn, allows the automatic processing of relatively subjective input from the testers. Each question may include an associated space for text input, such as 503, and that input is used to identify and correct problems which may or may not be sufficiently significant to preclude a general release of the upgrade software being tested.

In the fourth exemplary question, the user is enabled to input a number between “1” and “5” as an indicium of whether or not existing “portfolios” (this example assumes that the base program is a portfolio management program) can be migrated to the upgrade application. That input number can be multiplied by a weight factor to align it with the other answers in terms of significance. For example, for the fourth question, the number assigned by the tester may be multiplied by a factor of “100” so that if all existing portfolios can be migrated and a “0” is input, then a score of “0” is entered but if none of the portfolios can be migrated and a “5” is entered, then a score of “500” is counted during the analysis. The questions are continued as indicated 505 and at the end of the form there are hypertext indicia 507 and 509 which may be selected by the tester to “EXIT AND SAVE” 507 the form (for later completion for example), or to “SUBMIT TEST QUESTIONNAIRE” form 509 with the input answers to the ASP for analysis. The selection may be made by the tester through the use of a pointing indicium 511.

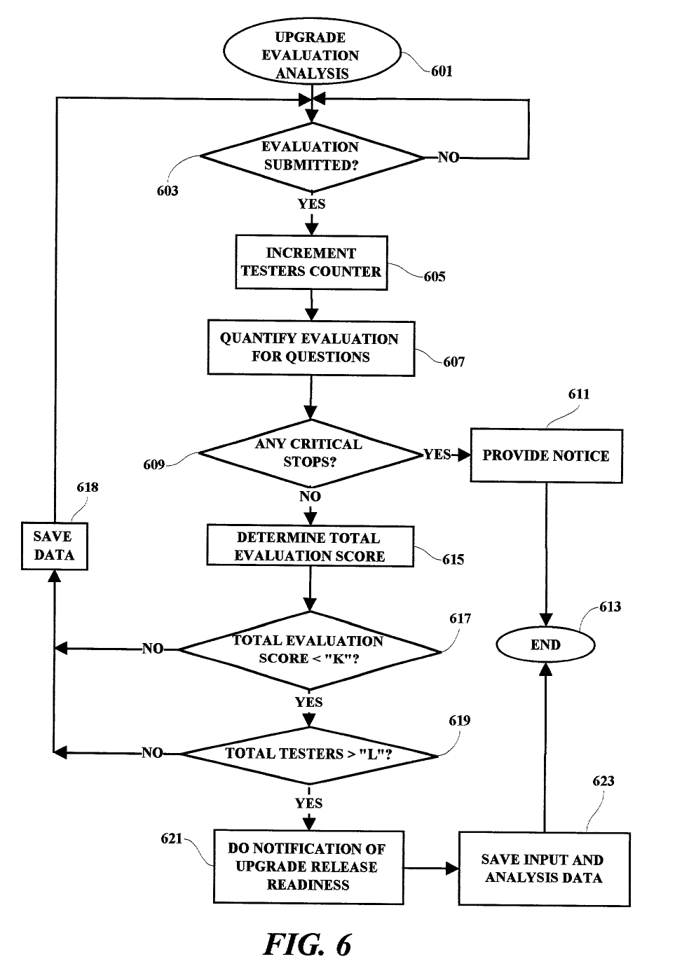

When the form has been completed and submitted back to the ASP for example, the upgrade evaluation analysis, as shown in FIG. 6, is initiated. As illustrated, when the evaluation begins 601 and a determination has been made that an evaluation questionnaire has been submitted 603, then a testers counter is incremented 605. It is noted that a “completeness” check could be made before incrementing the counter to make sure that the form had been fully completed before the answers are scored since incomplete forms would skew the results. The testers counter or other means for accomplishing the same function is used to keep track of the number of testers who have completed and submitted the questionnaire for evaluation. This is accounted for since there must be a minimum number of testers used to evaluate the upgrade application, as a matter of statistical analysis, before it can be deemed to be ready for general release. Next, the answers are quantified for analysis 607. This process includes the weighting function as described above in connection with FIG. 5. For example, during the quantification process 607, the “YES” answer to the second question (with a weighting factor of “300”) would yield a score of “300”, and the “YES” answer to the third question (with a weighting factor of “100”) would yield a score of “0”. Further, in the example, since the tester had a “crash” experience and answered the first question (which has a weighting factor of “1000”) with a “YES”, then the score for the first question is “1000”. The crash question is the most important and has the highest weighting factor assigned to it. The fourth question will return a score of “100” since the weighting factor is “10038 and the tester entered the number “1” indicating that one of the tester's portfolios could not be migrated to the upgrade application. It is noted that there will usually be more than the four questions in the questionnaire, but for purposes of illustration, if only the four specified questions were included, the quantified score would be the sum of “1000”, “300”, “0” and “100” for the four questions, respectively, which would yield a total score of “1400” for the questionnaire.

After the quantification of the answers 607, a check is made to determine if there are any “critical stops” 609 in the answers. In the example, the “crash” question is a critical question in analyzing for release readiness and so the “YES” answer to the first question would be considered a critical stop. When a critical stop is encountered, appropriate notice is provided 611 and, in the example, the processing is ended 613. It is noted that the program design may also allow continuation of the processing after notice of the “crash” answer but the existence of the crash during the test would seem to weigh against the credibility of the remaining answers to the questionnaire in that case. In the event there were no critical stops 609 in the answers, the total score would be determined 615 (as noted above) and a check is made to determine if the total score is less than a first predetermined score “K” 617. The number “K” is determined by the ASP to be a number which designates an acceptability level for the upgrade. If the total score, for example, is above the number “K” in the negative weighting example used, then the upgrade may be deemed to be unacceptable (i.e. has too many problems) for general release. A score below “K” will indicate fewer problems in the example and may indicate that the upgrade program being analyzed is acceptable for general release. Thus, if the total score is not less than “K” 617, the data is saved 618 and the processing returns to await the next submission of an evaluation questionnaire 603.

If the total score is determined to be less than “K” 617, then a check is made to determine if the total number of testers, including the current tester, is greater than a second predetermined number “L” 619. The value of the number “L” will be determined such that the test results are based on a valid statistical number of samples or testers. If that number of testers “L” has not yet provided input 619, then the processing saves the data 618 and returns to await the next questionnaire submission 603. Once a minimum number of testers “L” have submitted questionnaires 619 with “problem” scores below “K” 617, then a notification process is initiated 621 to indicate that the “beta” testing has -yielded results supportive of a general release of the upgrade program 621. That notice may be in any of many forms. For example the notice of release readiness 621 may be a form email sent to a portable or wireless or other device carried by a product manager for the upgrade release. The notice may also be an “instant” message to a handheld device and/or a display on a computer screen. The notice, as well as the input and analysis data may also be saved in a persistent medium 623 at the ASP server, for example, for later recall. After saving the results and the final notice 623, the processing is ended 613.

Thus, there has been provided a method and system for ASP providers to obtain testing feedback from existing users about the usability of new versions of their software with the existing versions of the ASP's client code. In an example, the new version of the ASP is set up on a server and the existing version clients are allowed to register and run against the new or upgrade version software. Feedback concerning the new upgrade from the registered existing clients is then quantified and analyzed, and migration to the new version is enabled after all of the problems, if any, have been identified and resolved.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing testing results of an upgrade version of a base application, said method comprising:
enabling said user to test said upgrade version;
displaying a questionnaire regarding test results of said user, said questionnaire being designed to enable said user to input a predetermined number of possible answers;
receiving answers to said questionnaire from said user;
assigning a quantitative value to each of said possible answers to provide a quantitative score for each question on said questionnaire; and
automatically evaluating said quantitative score for each of said questions to provide an indication of acceptability of said upgrade version.

2. The method as set forth in claim 1 wherein said quantitative values are assigned in a manner to provide a lower total score for questionnaire answers more favorable to acceptability of said upgrade version.

3. The method as set forth in claim 2 wherein said upgrade version is notified as being acceptable if said total score for said questionnaire is lower than a predetermined number.

4. The method as set forth in claim 2 wherein said quantitative values are assigned in a manner to provide a higher total score for questionnaire answers more favorable to acceptability of said upgrade version.

5. The method as set forth in claim 4 wherein said upgrade version is notified as being acceptable if said total score for said questionnaire is higher than a predetermined number.

6. The method as set forth in claim 1 wherein detection of an answer indicating that said user experienced an inoperable condition during a test of said upgrade version is effective to provide a notice of non-acceptability of said upgrade version regardless of answers received for other questions in said questionnaire.

7. The method as set forth in claim 1 wherein a favorable total score for answers to said questionnaire is provided by a predetermined minimum number of testers before said upgrade version is indicated as being acceptable.

8. The method as set forth in claim 1 and further including:
detecting said indication of acceptability; and
automatically sending a predetermined message in response to said detecting.

9. The method as set forth in claim 8 wherein said predetermined message is sent by email.

10. The method as set forth in claim 8 wherein said predetermined message is sent to a designated address of a computer device.

11. The method as set forth in claim 8 wherein said predetermined message is sent to a wireless device.

12. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable processing of testing results of an upgrade version of a base application, said program signals being selectively operable for:
enabling said user to test said upgrade version;
enabling a display of a questionnaire regarding test results of said user, said questionnaire being designed to allow said user to input a predetermined number of possible answers;
enabling a receipt of answers to said questionnaire from said user;
assigning a quantitative value to each of said possible answers to provide a quantitative score for each question on said questionnaire; and
automatically evaluating said quantitative score for each of said questions to provide an indication of acceptability of said upgrade version.

13. The medium as set forth in claim 12 wherein said quantitative values are assigned in a manner to provide a lower total score for questionnaire answers more favorable to acceptability of said upgrade version.

14. The medium as set forth in claim 13 wherein said upgrade version is notified as being acceptable if said total score for said questionnaire is lower than a predetermined number.

15. The medium as set forth in claim 13 wherein said quantitative values are assigned in a manner to provide a higher total score for questionnaire answers more favorable to acceptability of said upgrade version.

16. The medium as set forth in claim 15 wherein said upgrade version is notified as being acceptable if said total score for said questionnaire is higher than a predetermined number.

17. The medium as set forth in claim 12 wherein detection of an answer indicating that said user experienced an inoperable condition during a test of said upgrade version is effective to provide a notice of non-acceptability of said upgrade version regardless of answers received for other questions in said questionnaire.

18. The medium as set forth in claim 12 wherein a favorable total score for answers to said questionnaire is provided by a predetermined minimum number of testers before said upgrade version is indicated as being acceptable.

19. The medium as set forth in claim 12 wherein said program signals are further selectively operable for:
detecting said indication of acceptability; and
automatically sending a predetermined message in response to said detecting.

20. The medium as set forth in claim 19 wherein said predetermined message is sent by email.

21. The medium as set forth in claim 19 wherein said predetermined message is sent to a designated address of a computer device.

22. The medium as set forth in claim 19 wherein said predetermined message is sent to a wireless device.

23. A system for processing testing results from testing an upgrade version of a base application, said system including:
a system bus;
a CPU device connected to said system bus; and
a memory device connected to said system bus, said memory device including program code, said program code being selectively accessible for enabling said user to test said upgrade version, said system being selectively operable for:
enabling a display on a user device of a questionnaire regarding test results of said user, said questionnaire being designed to allow said user to input a predetermined number of possible answers;
enabling a receipt of answers to said questionnaire from said user;
assigning a quantitative value to each of said possible answers to provide a quantitative score for each question on said questionnaire; and
automatically evaluating said quantitative score for each of said questions to provide an indication of acceptability of said upgrade version.

24. The system as set forth in claim 23 wherein said quantitative values are assigned in a manner to provide a lower total score for questionnaire answers more favorable to acceptability of said upgrade version.

25. The system as set forth in claim 24 wherein said upgrade version is notified as being acceptable if said total score for said questionnaire is lower than a predetermined number.

26. The system as set forth in claim 23 wherein said quantitative values are assigned in a manner to provide a higher total score for questionnaire answers more favorable to acceptability of said upgrade version.

27. The system as set forth in claim 26 wherein said upgrade version is notified as being acceptable if said total score for said questionnaire is higher than a predetermined number.

28. The system as set forth in claim 23 wherein a favorable total score for answers to said questionnaire is provided by a predetermined minimum number of testers before said upgrade version is indicated as being acceptable.

29. The system as set forth in claim 23 wherein said system is further selectively operable for detecting said indication of acceptability and automatically sending a predetermined message in response to said detecting.
